(19) United States
(12) Patent Application Publication
(10) Pub. No.: US 2009/0252967 A1
(43) Pub. Date: Oct. 8, 2009

(54) CARBON NANOTUBE TRANSPARENT ELECTRODE AND METHOD OF MANUFACTURING THE SAME

(75) Inventors: Seonmi YOON, Yongin-si (KR); Jaeyoung CHOI, Suwon-si (KR); Hyeon Jin SHIN, Suwon-si (KR); Ungyu PAIK, Seoul (KR); In Sung CHA, Seoul (KR)

Correspondence Address: CANTOR COLBURN, LLP, 20 Church Street, 22nd Floor, Hartford, CT, 06103, US

(73) Assignees: SAMSUNG ELECTRONICS, CO., LTD., Suwon-si (KR); IUCF-HYU (INDUSTRY-UNIVERSITY COOPERATION FOUNDATION HANYANG UNIVERSITY), Seoul (KR)

(21) Appl. No.: 12/251,561

(22) Filed: Oct. 15, 2008

(30) Foreign Application Priority Data
Apr. 3, 2008 (KR) 10-2008-0031403

(51) Int. Cl. B32B 27/06; B05D 5/12

(52) U.S. Cl. 428/408; 427/122; 977/890; 977/778

(57) ABSTRACT

A CNT transparent electrode may have a CNT layer consisting essentially of CNT only, together with a cover layer that may include conductive particles and a polymer. The cover layer may cover an upper and/or a lower portion of the CNT layer. The CNT transparent electrode including the CNT layer which essentially consists of CNT only and does not contain other materials such as a binder or a dispersing agent can exhibit excellent conductivity. When the CNT layer is covered by the cover layer, surface roughness, film uniformity, adhesion between the CNT transparent electrode and the substrate and stability in the process of applying the CNT transparent electrode to devices can be enhanced, compared to the case where only the CNT layer is used.

This application claims priority to Korean Patent Application No. 10-2008-0031403, filed on Apr. 3, 2008, and all the benefits accruing therefrom under U.S.C. § 119, the entire contents of which are hereby incorporated by reference.

### BACKGROUND

1. Field of the Invention

This disclosure relates to a carbon nano-tube (CNT) transparent electrode and a method of manufacturing the same.

2. Description of the Related Art

CNTs have excellent conductivity as well as strength, and can be bent easily without breaking. Therefore, CNTs can be used to manufacture flexible transparent electrodes.

A flexible transparent electrode using CNTs (hereinafter “CNT transparent electrode”) can be applied to various display devices such as liquid crystalline displays (LCD), organic light emitting diodes (OLED), paper-like display, and the like. Further, the flexible transparent electrode can be applied to energy devices such as solar cells.

For manufacturing a CNT transparent electrode, CNT powder may be dispersed in a solution containing a dispersing agent so as to prepare CNT ink, and then the CNT ink may be applied to form a CNT layer. The CNT layer can be used as the CNT transparent electrode. The CNT layer is known to have a network structure.

### SUMMARY

The inventors disclose an exemplary embodiment of a novel carbon nano-tube (CNT) transparent electrode, which includes a CNT layer and a cover layer for the CNT layer. The CNT layer may consist essentially of CNTs only without other materials such as binders or dispersing agents in order to enhance electrical conductivity. Further, the cover layer may include conductive particles and a polymer. The cover layer may be formed together with the CNT layer in order to prevent problems possibly occurring when using only the CNT layer (without the cover layer) as part of the CNT transparent electrode. The presence of the CNT layer without the cover layer may lead to problems, such as for example, a reduction of surface roughness or of film uniformity. Further, it can lead to a reduction of adhesion between a CNT transparent electrode including the CNT layer without the cover layer and a substrate, which may lead to a reduction in the stability of the process of applying the CNT transparent electrode to devices.

Disclosed herein too is an exemplary embodiment wherein a CNT transparent electrode comprises a CNT layer and a cover layer covering an upper and/or a lower portion of the CNT layer, the CNT layer consisting essentially of CNTs only, and the cover layer comprising conductive particles and a polymer.

Disclosed herein too is an exemplary embodiment wherein a method of manufacturing a CNT transparent electrode comprises forming a CNT layer consisting essentially of CNTs only, and forming a cover layer covering an upper and/or a lower portion of the CNT layer, the cover layer comprising conductive particles and a polymer.

Since the CNT layer essentially consists of CNTs only and does not contain other materials such as organic materials, which may reduce electrical conductivity, the CNT layer can contribute to enhancing the conductivity of the CNT transparent electrode.

Meanwhile, since the cover layer covering the CNT layer comprises conductive particles, the cover layer can contribute to enhancing the conductivity of the CNT transparent electrode. Further, since the cover layer covering the CNT layer comprises a polymer, the cover layer can contribute to enhancing roughness or film uniformity as well as adhesion between the CNT transparent electrode and the substrate, which may improve stability in the process of applying the CNT transparent electrode to devices.

### BRIEF DESCRIPTION OF THE DRAWINGS

The above and other objects, features and advantages of the disclosed embodiments will be more apparent from the following detailed description taken in conjunction with the accompanying drawings in which:

FIGS. 1 to 3 are schematic views of carbon nano-tube (CNT) transparent electrodes according to exemplary embodiments.

FIG. 4 is schematic depiction of polymer having electron-withdrawing group, which is used in composition as cover layer according to exemplary embodiments.

FIG. 5 is graph showing changes in surface roughness and sheet resistance depending upon ratio of cover layer defined according to Example 1.

### DETAILED DESCRIPTION OF EMBODIMENTS

Exemplary embodiments now will be described more fully hereinafter with reference to the accompanying drawings, in which exemplary embodiments are shown. The invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. In the description, details of well-known features and techniques may be omitted to avoid unnecessarily obscuring the presented embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. The use of the terms “first”, “second”, and the like do not imply any particular order, but are included to identify individual elements. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements and shape, size and regions, and the like, are exaggerated for clarity.

In an exemplary embodiment, a carbon nano-tube (CNT) transparent electrode may include CNT layer and a cover layer covering an upper and/or a lower portion of the CNT layer. The CNT layer may consist essentially of CNTs only without other materials such as binders, dispersing agents or the like. The cover layer may include conductive particles and a polymer. As in a non-limiting exemplary embodiment, the CNT transparent electrode may be formed on a substrate. As in yet another non-limiting exemplary embodiment, the CNT transparent electrode may be formed not on a substrate but rather on other layers in the device. For instance, in the case of manufacturing an organic light emitting diode (OLED), a cathode can be formed not on a substrate but on an electron transport layer (ETL). Where the CNT transparent electrode can be formed may be different depending upon concrete sorts or designs of devices for which the CNT transparent electrode is supposed to be used, or concrete manufacturing processes of the devices.

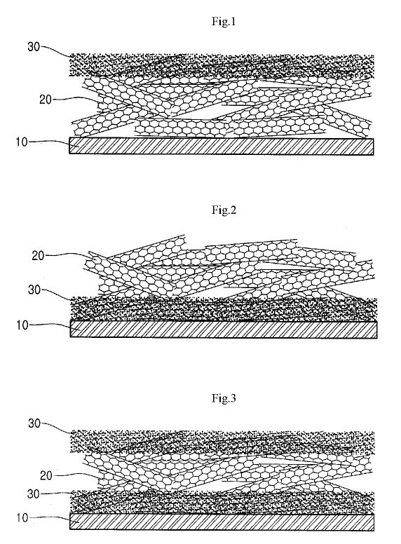

FIGS. 1 to 3 are schematic views of CNT transparent electrodes according to exemplary embodiments.

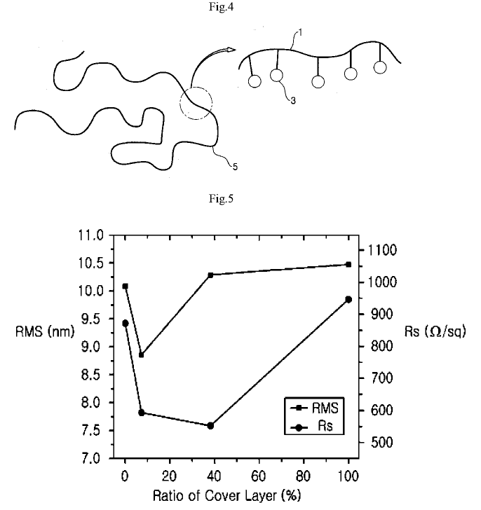

Referring to FIGS. 1 to 3, the CNT transparent electrode may be but not limited to be formed on a substrate 10. The CNT transparent electrode has a CNT layer 20, which is formed on the substrate 10, and a cover layer 30, which covers the upper portion (refer to FIG. 1), the lower portion (refer to FIG. 2), or the upper and lower portions (refer to FIG. 3) of the CNT layer 20.

The covering of the upper and/or lower portion of the CNT layer 20 with the cover layer 30 means not only covering the entire upper and/or lower portion of the CNT layer 20 but also covering a part or parts of the upper and/or lower portion of the CNT layer 20.

For enhancing conductivity, the CNT layer 20 can be made to consist essentially of CNTs only. In case of general formation of the CNT layer 20, an organic material such as a dispersing agent may be added to the CNTs. Since the organic material can be an insulator, the organic material may usually decrease the electrical conductivity of the CNT layer. In order to prevent a decrease in the electrical conductivity of the CNT layer and enhance electrical conductivity of the overall CNT transparent electrode comprising the CNT layer, the CNT layer 20 can be made to essentially consist of CNTs only. In other words, the CNT layer 20 is manufactured such that the CNT layer 20 does not contain a dispersing agent or if a dispersing agent is used during the manufacturing, it is eventually removed.

When the dispersing agent is not added in the beginning of the manufacturing process or is removed after the manufacturing process, the surface roughness or film uniformity of the CNT transparent electrode can be reduced because the dispersing agent may be a polymer. The polymer can serve to improve the surface roughness or film uniformity. Further, if the CNT layer contacts with a substrate, a difference in polarity between the CNT layer and the substrate can occur because the substrate may comprise plastics that having a similar polarity as the dispersing agent. The polarity difference can cause reduction of adhesion between the CNT layer and the substrate, which may damage the CNT. Such damages can be directed to degradation of the characteristics of the CNT layer. Meanwhile, in the case of adhesion reduction, it can be difficult to form other components or materials on the CNT transparent electrode stably. That is, the adhesion reduction can result in the reduction of the process stability during the manufacturing of devices that contain the CNT transparent electrode.

Therefore, the dispersing agent, which is an organic material, is made to be removed from the CNT layer 20, or the CNT layer 20 is made of CNT only without the dispersing agent from the beginning in order to enhance conductivity. Further, the CNT layer 20 is covered by the cover layer 30. The cover layer 30 may comprise a polymer and conductive particles so as to make up for the possible reduction of roughness or film uniformity as well as reductions of adhesion and stability due to the removal of the dispersing agent or non-existence of the dispersing agent from the beginning.

When the CNT layer 20 is covered by the cover layer 30, the roughness or film uniformity of the overall CNT transparent electrode can be reduced due to the presence of the polymer in the cover layer 30. Further, the adhesion of the CNT transparent electrode to the substrate 10, when the substrate 10 is composed of plastics (polymers) can be improved, which improves the stability in the process of applying the CNT transparent electrode to devices.

Since the cover layer 30 may comprise conductive particles in addition to the polymer, the electrical conductivity of the cover layer 30 can be increased when compared with cover layers 30 that are composed of the polymer only.

As for non-limiting examples of electrically conductive particles, metal particles, carbon black, CNTs, or the like, or a combination comprising at least one of the foregoing electrically conductive particles may be used.

As for non-limiting examples of the polymer, various polymers such as polyacetal, polycarbonate, polystyrene, polymethylmethacrylate, polyester, polyvinyl alcohol, polytetrafluoroethylene, polypyrrolidone, any combination thereof, or the like may be used.

In one embodiment, the conductive particle of the cover layer 30 can be, for example, CNTs or metal particle, while the polymer can have an electron withdrawing group. The polymer having an electron withdrawing group can render the metal particles or a part of the CNTs p-doped, thereby enhancing the electrical conductivity of the CNT or the metal particles. In addition, the polymer can also serve to disperse the CNTs or the metal particles.

FIG. 4 is a schematic view of the polymer having an electron withdrawing group, which is used in a composition for a cover layer according to an exemplary embodiment.

Referring to FIG. 4, the polymer 5 having an electron withdrawing group has a structure in which an electron withdrawing group (functional group) 3 is coupled to a backbone 1.

The polymer having electron withdrawing groups serves to reduce contact resistance between the CNTs.

CNT can be classified into metallic CNT and semiconducting CNT depending upon its electrical characteristics. Armchair-type CNTs with no chirality are metallic CNT, the band gap of which is 0. Depending on chirality, CNT can be sorted into metallic CNT and semiconducting CNT. Contact resistance can exist between the metallic CNT and the semiconducting CNT since the band gaps of the metallic and semiconducting CNT are different from each other. For example, when electrons flow into metallic CNT (conductance of the metallic CNT per se is 4 e²/h) from the semiconducting CNT (conductance of the semiconducting CNT per se is 0.1 e²/h), the conductance between the metallic CNT and the semiconducting CNT can be as low as 0.0008 e²/h. The phenomenon of the so called Schottky barrier, can serve as the main cause of conductance reduction in the CNT network structure.

When using the polymer having an electron-withdrawing group, the CNT can be p-doped by the electron-withdrawing group. The electron-withdrawing group easily attracts electrons from the CNT due to its electron affinity. Further, CNT distribution can be stabilized in the CNT layer can be stabilized.

When the polymer having an electron-withdrawing group is mixed with CNT comprising metallic CNTs and semiconducting CNTs, the electron withdrawing group can take electrons from metallic and semiconducting bands located in the vicinity of the Fermi level of the CNTs. That is, the electron density in the bands between the metallic and semiconducting CNTs can be adjusted. As a result, the Schottky barrier can be controlled so that the contact conductance increases. For reference, when an acid treatment is performed during the manufacturing of CNTs, the CNT may be weakly p-doped. When the weakly p-doped CNT is mixed with the polymer having an electron withdrawing group, the degree of p-doping can increase.

Meanwhile, when conductive particles such as CNTs or metal particles is p-doped by using the polymer having an electron withdrawing group, the polymer can serve as a dispersing agent for the conductive particles. Therefore, the dispersing capabilities of the conductive particles can be enhanced. Further, since the polymer (a high molecular weight compound), serves as the dopant, the doping stability can also be enhanced, compared to those case where the conductive particles (such as the CNTs or metal particles) are doped with low molecular weight compounds. In addition, the adhesion of the CNT transparent electrode to the plastic substrate can be enhanced, which means that when the CNT transparent electrode is applied to a device, thermal stability may be enhanced and there may only a very small change in the characteristic performance of the CNT transparent electrode over time.

As for non-limiting examples of the electron withdrawing group, —COOR, —COR, —CONR₂, —SO₃H, —NO₂, —NO, —CN, —CF₃, —S═O, —NR₄⁺, —F, —Cl, —Br, or the like, or a combination comprising at least one of the foregoing electron withdrawing groups can be used. Herein, R represents H, Na, K, or C₁-C₄ alkyl or aryl.

As for non-limiting examples of the backbone, cellulose, polyacryl, polyacetal, polystyrene, polyester, polyvinyl, polytetrafluoroethylene, or the like, may be used.

As for non-limiting examples of the polymer having an electron withdrawing group, polyacrylic acid, polystyrene sulfonate, perfluorocarbonsulfonic acid, sodium polyacrylate, sodium polyanetholesulfonate, nitrocellulose, or the like, may be used.

Methods of manufacturing the CNT transparent electrode according to exemplary embodiments of the invention will be described hereinafter.

As an exemplary embodiment, a case where a CNT layer 20 is formed on a substrate 10 and an upper cover layer 30 is formed on the CNT layer 20 will be described (refer to FIG. 1).

First, a film is formed by spraying a solution on the substrate 10, the solution being obtained by dispersing CNT powder in a solvent with a dispersing agent. Subsequently, a solution containing conductive particle and polymer is sprayed onto the film (i.e., CNT layer) so as to form the upper cover layer 30. Since the film contains the dispersing agent as well as the CNT, the film is washed so as to remove the dispersing agent. The washing of the film can be performed either before or after the formation of the upper cover layer 30.

In another exemplary embodiment, a case where a lower cover layer 30 is formed on a substrate 10 and a CNT layer 20 is formed on the lower cover layer 30 will be described (refer to FIG. 2).

First, the lower cover layer 30 is formed by spaying a solution onto the substrate 10, the solution containing conductive particle and polymer. Next, a solution obtained by dispersing CNT powder in a solvent with a dispersing agent is sprayed on the lower cover layer 30 so as to form a film. Since the film contains the dispersing agent as well as the CNT, the film is washed to remove the dispersing agent.

As for a another exemplary embodiment, a case where a lower cover layer 30 is formed on a substrate 10, a CNT layer 20 is formed on the lower cover layer 30, and an upper cover layer 30 is formed on the CNT layer 20 will be described (refer to FIG. 3).

First, the lower cover layer 30 is formed by spraying a solution onto the substrate 10, the solution containing conductive particle and polymer. Next, a solution obtained by dispersing CNT power in a solvent with a dispersing agent is sprayed onto the lower cover layer 30 so as to form a film. Then, a solution containing conductive particle and polymer is sprayed onto the film so as to form the upper cover layer 30.

Since the film contains the dispersing agent as well as the CNT, the film is washed to remove the dispersing agent. As described above, the washing of the film can be performed either before or after the formation of the upper cover layer 30.

In yet another exemplary embodiment, the CNT layer 20 can be formed without the use of a dispersing agent. For example, CNTs subjected to an acid treatment are dispersed into a polar solvent such as water or alcohol, and the solvent is processed in a sonic bath or the like. Then, the processed solvent is put into a centrifugal separator for preparing a CNT-dispersed solution. In the case where a dispersing agent is not used, there is no need to remove the dispersing agent after the formation of the film. Therefore, the process can be simplified.

The invention will now be described in further detail with reference to the following examples. The following examples and experiments are for illustrative purposes only and not intended to limit the scope of the claimed invention.

[Preparing Dispersion Solution]

Preparing CNT-Layer Forming Solution

First, 15 mg of sodium dodecylbenzene sulfonate (NaDDBS), which is a dispersing agent, was dissolved in 30 mL of water, and 15 mg of single wall carbon nano-tube (SWCNT) powder (available from Iljin in Nanotech Co., Ltd) was added to the solution. The solution was then processed in a sonic bath for 10 hours, and then in centrifugal separator at 10,000 rpm for 10 minutes, thereby preparing a well-dispersed solution.

Preparing Cover-Layer Forming Solution

First, 60 mg of 25% water solution of PAA (polyacrylic acid) was dissolved in 30 mL of water, and 15 mg of SWCNT powder (available from Iljin Nanotech Co., Ltd) was added to the solution. Then, the solution was processed in a sonic bath for 10 hours, and then in a centrifugal separator at 10,000 rpm for 10 minutes, thereby preparing a well-dispersed solution.

[Manufacturing Upper-Cover-Type Electrode]

First, a substrate polyethylene terephthalate or polyethylene naphthalate (PET or PEN) was prepared, and the CNT-layer forming solution was sprayed onto the prepared substrate so as to form a CNT layer. Subsequently, the cover-layer forming solution was sprayed onto the CNT layer. Then, the CNT layer was washed to remove the dispersing agent within the CNT layer. The removing of the dispersing agent within the CNT layer can be performed either before the cover-layer forming solution is sprayed or after the cover-layer forming solution is sprayed. The manufactured electrode thus prepared is an upper-cover-type electrode since it has the cover layer covering the upper portion of the CNT layer (refer to FIG. 1).

[Manufacturing Lower-Cover-Type Electrode]

First, a substrate (PET or PEN) was prepared, and the cover-layer forming solution was sprayed onto the prepared substrate so as to form a cover layer. Subsequently, the CNT-layer forming solution was sprayed onto the cover layer so as to form a CNT layer. Then, the CNT layer was washed to remove the dispersing agent within the CNT layer. The manufactured electrode thus prepared is a lower-cover-type electrode since it has the cover layer covering the lower portion of the CNT layer (refer to FIG. 2).

[Manufacturing Upper-and-Lower-Cover-Type Electrode]

First, a substrate (PET or PEN) was prepared, and the cover-layer forming solution was sprayed onto the prepared substrate so as to form the cover layer. Subsequently, the CNT-layer forming solution was sprayed onto the cover layer so as to form the CNT layer. Then, the cover-layer forming solution was sprayed again onto the CNT layer. The CNT layer was washed to remove the dispersing agent within the CNT layer. The removing of the dispersing agent within the CNT layer can be performed either before the cover-layer forming solution is sprayed or after the cover-layer forming solution is sprayed. The manufactured electrode thus prepared is an upper-and-lower-cover-type electrode since it has the cover layer covering both the upper and lower portions of the CNT layer (refer to FIG. 3).

[Adjusting Layer Formation Ratio]

To adjust a ratio (degree) of formation of the cover layer and CNT layer, the number of sprayings of the CNT-layer forming solution and the cover-layer forming solution was adjusted. In another embodiment, the ratio (degree) of formation of the cover layer and CNT layer was adjusted by adjusting the concentration of the CNT-layer forming solution and the cover-layer forming solution.

[Measurements]

Measuring Sheet Resistance

A four point probe sheet-resistance measuring apparatus (Changmin Tech, CMT-series) was used to measure sheet resistance.

Measuring Transmittance

UV-Vis-NIR spectroscopy (Cary 5000) was used to measure transmittance at 550 nm.

Roughness Measuring Apparatus

AFM (atomic force microscope) was used to analyze surface roughness (RMS). For reference, the larger RMS means the rougher surface.

### Experiment 1

### Characteristic Change Depending on Cover-Layer Formation Ratio

An experiment was carried out measuring characteristic changes depending on the cover-layer formation ratio with respect to the entire layer. Here the electrode type was the upper-cover-type, and PET was used as the substrate.

The cover-layer formation ratio can be defined as follows. First, the total weight of the entire layer can be represented by Expression 1.

Total weight of CNT in entire layer=weight of CNT layer+weight of CNT present in the cover layer Expression 1

For reference, since the CNT layer is composed of CNT only after washing, the weight of the CNT layer is the weight of the CNT in the CNT layer. Since the cover layer is composed of CNT (conductive particle) and polymer, the weight of the cover layer can be calculated by adding the weight of polymer and the weight of CNT.

The ratio of the cover layer can be represented by Expression 2.

Ratio of Cover Layer (%)=[weight of CNT present in the cover layer/total weight of CNT in entire layer]×100 Expression 2

Expressions 1 and 2 are not limited merely to the case where CNT is used as the conductive particle in the cover layer, but can be applied to other cases where other conductive particles such as metallic particles are used in the cover layer. For example, when the metallic particles are used as the conductive particles in the cover layer, the “total weight of CNT in entire layer” in Expressions 1 and 2 can be replaced with “total weight of CNT and metallic particles in entire layer,” and the “weight of CNT present in the cover layer” in Expressions 1 and 2 can be replaced with “weight of metallic particles present in the cover layer.”

For the cases where the ratio of cover layer was set to be 0, 8, 38, and 100%, respectively, roughness, sheet resistance, and transmittance were measured. Table 1 shows the measurement results. Here, the case where the ratio of cover layer is 0% means that only the CNT layer is formed without the cover layer. And, the case where the ratio of cover layer is 100% means that the CNT layer is not formed but only the cover layer is formed on the substrate without the CNT layer.

TABLE 1

| Ratio of cover | Roughness | Sheet Resistance | |
|---|---|---|---|
| layer | (RMS) | (Rs) | Transmittance |
| 0% | 10.700 nm | 872.4 Ω/sq | 89.4% |
| 8% | 8.847 nm | 593.7 Ω/sq | 88.4% |
| 38% | 10.260 nm | 552.9 Ω/sq | 88.4% |
| 100% | 10.440 nm | 944.9 Ω/sq | 90.2% |

As shown in Table 1, in the case where the CNT layer and the cover layer are formed together (Ratio of Cover Layer=8, 38%), the roughness and the sheet roughness is lower when compared with those cases where only the CNT layer is formed on PET substrate (ratio of cover layer=0%) or where only the cover layer is formed without the CNT layer (ratio of cover layer=100%). FIG. 5 is a graph showing changes in surface roughness and sheet resistance depending upon the ratio of cover layer.

When the cover layer for the CNT layer is formed, the ratio of cover layer can be determined. The ratio of cover layer may differ depending on the type of conductive particles or the polymer. Further, the ratio of cover layer may differ depending on the electrode type such as upper-cover-type, lower-cover-type, upper-and-lower-cover-type, or the like. Therefore, the ratio of cover layer can be determined based on the result of the roughness, sheet resistance characteristics, and the like, while changing the types of conductive particles or polymer, or the electrode types. In various experiments using different types of conductive particles, different types of polymers and different types of the electrodes, the ratio of cover layer was determined to be 60% or less even though the type of conductive particles, polymers and electrodes were changed.

### Experiment 2

### Characteristic Change Depending on Electrode Type

The ratio of cover layer was set to be 37%, which is approximate to the ratio of cover layer of Experiment 1 (38%), and the electrode types on the substrate (PEN) were set to be lower-cover-type and upper-and-lower-cover-type, differently from that of Experiment 1. In the case where the upper-and-lower-cover-type was adopted, 7.4% of 37% was set to correspond to the cover layer covering the upper portion of the electrode. Table 2 shows the experiment results.

TABLE 2

| | | Sheet | |
|---|---|---|---|
| | Roughness | resistance | Trans- |
| | (RMS) | (Rs) | mittance |
| Lower-cover-type | 7.489 nm | 534.77 Ω/sq | 87.0% |
| electrode [ratio of | | | |
| cover layer - 37%] | | | |
| Upper-and-lower- | 5.824 nm | 525.71 Ω/sq | 87.4% |
| cover type electrode | | | |
| [ratio of cover layer - | | | |
| 37%; upper portion | | | |
| 7.4% + lower portion | | | |
| 29.6%] | | | |

As shown in Table 2, when the lower-cover-type electrode was used, the roughness decreased to 7.489 nm, and the sheet resistance decreased to 534.77 Ω/sq. And, when the upper-and-lower-cover-type electrode was used, the roughness further decreased to 5.824 nm, and the sheet resistance further decreased to 525.71 Ω/sq.

### Experiment 3

### Change in Composition of Cover-Layer Forming Solution

The ratio of cover layer was set to be 31%, the type of the polymer in the cover-layer forming solution was replaced with polystyrene sulfonic acid (PSS) and Nafion®, the electrode type was set to be lower-cover-type, and the substrate was PET substrate. Table 3 shows the experiment results. For reference, Table 3 also shows the case where the ratio of cover layer is 0% and the case where polyacrylic acid (PAA) is used and the ratio of cover layer is 37%.

TABLE 3

| Ratio of Cover | Roughness | Sheet resistance | |
|---|---|---|---|
| Layer | (RMS) | (Rs) | Transmittance |
| 0% | 10.700 nm | 872.4 Ω/sq | 89.4% |
| 37% (PAA used) | 10.257 nm | 471.3 Ω/sq | 88.5% |
| 37% (PSS used) | 10.459 nm | 478.1 Ω/sq | 89.1% |
| 37% (Nafion ® | 10.440 nm | 750.0 Ω/sq | 89.7% |
| used) | | | |

As shown in Table 3, when PSS was used, the sheet resistance and the roughness were 478.1 Ω/sq and 10.495 nm, respectively. When Nafion® was used, the sheet resistance was 750.0 Ω/sq and the roughness was 10.440 nm. The sheet resistance in the case using Nafion® can be further reduced by adjusting the ratio of cover layer, but the ratio of cover layer did not exceed about 60%.

While the invention has been shown and described with reference to certain exemplary embodiments thereof, it will be understood by those skilled in the art that various changes in form and details may be made thereto without departing from the spirit and scope of the invention as defined by the appended claims.

In addition, many modifications can be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguished one element from another. Furthermore, the use of the terms a, an, etc. do not denote a limitation of quantity, but rather denote the presence of at least one of the referenced item.

What is claimed is:

1. A carbon nano-tube transparent electrode comprising:
a carbon nano-tube layer consisting essentially of carbon nano-tube only; and
a cover layer covering an upper and/or a lower portion of the carbon nano-tube layer; the cover layer comprising conductive particles and a polymer.

2. The carbon nano-tube transparent electrode according to claim 1, wherein the polymer is a dopant for doping the conductive particle.

3. The carbon nano-tube transparent electrode according to claim 1, wherein the polymer is selected from the group consisting of polyacrylic acid, polystyrene sulfonate, perfluorocarbonsulfonic acid, sodium polyacrylate, sodium polyanetholesulfonate, nitrocellulose, and a combination comprising at least one of the foregoing polymers.

4. The carbon nano-tube transparent electrode according to claim 1, wherein the conductive particle is a carbon nano-tube or metallic particle, and the polymer has an electron-withdrawing group.

5. The carbon nano-tube transparent electrode according to claim 1, wherein the cover layer covers the upper and lower portions of the carbon nano-tube layer.

6. The carbon nano-tube transparent electrode according to claim 1, wherein a ratio of the cover layer is defined as a weight percent of the conductive particle present in the cover layer divided by the sum of the weight of the CNT layer and the weight of the conductive particle present in the cover layer, and wherein the ratio of the cover layer is up to about 60%.

7. The carbon nano-tube transparent electrode according to claim 6, wherein the conductive particle is carbon nano-tube, the polymer is polyacrylic acid, and the ratio of the cover layer is up to about 40%.

8. The carbon nano-tube transparent electrode according to claim 1, wherein the substrate comprises a polymer.

9. The carbon nano-tube transparent electrode according to claim 8, wherein the polymer is selected from the group consisting of polyethylene terephthalate, polyethylene naphthalate, or a combination comprising at least one of the foregoing polymers.

10. An article comprising the carbon nano-tube transparent electrode of claim 1

11. The article according to claim 10, wherein the article further comprises a substrate, and the carbon nano-tube layer or the cover layer is in contact with the substrate.

12. A method of manufacturing a carbon nano-tube transparent electrode, comprising:
forming a carbon nano-tube layer consisting essentially of carbon nano-tubes only; and
forming a cover layer; the cover layer being disposed on an upper and/or a lower portion of the carbon nano-tube layer, the cover layer comprising conductive particles and a polymer.

13. The method according to claim 12, wherein a solution comprising carbon nano-tubes and a dispersing agent is used to form the carbon nano-tube layer, following which the dispersing agent is removed from the carbon nano-tube layer.

14. The method according to claim 12, wherein the carbon nano-tube layer is formed from a polar solution that comprises acid treated carbon nano-tubes.

15. The method according to claim 12, wherein when a ratio of the cover layer is defined as a weight percent of the conductive particle present in the cover layer with respect to the sum of the weight of the carbon nano-tube layer and the weight of the conductive particle present in the cover layer, the types of the conductive particle or polymer or the formation positions of the cover layer are changed so as to determine the ratio of the cover layer.

16. The method according to claim 12, wherein the carbon nano-tube layer or the cover layer is formed to be in contact with a substrate.

17. An article manufactured by the method of claim 12.
